(19) United States
(12) Patent Application Publication
(10) Pub. No.: US 2009/0256298 A1
(43) Pub. Date: Oct. 15, 2009

(54) TURNTABLE AND WORKING MACHINE WITH SUCH TURNTABLE

(76) Inventors: Ichiro Kitaura, Hyogo (JP); Hiroyuki Yotsubayashi, Hyogo (JP); Takashi Ninomiya, Hyogo (JP)

Correspondence Address: BIRCH STEWART KOLASCH & BIRCH, PO BOX 747, FALLS CHURCH, VA, 22040-0747, US

(21) Appl. No.: 12/439,119

(22) PCT Filed: Dec. 7, 2007
(86) PCT No.: PCT/JP2007/073651

§ 371 Date: Feb. 26, 2009

(30) Foreign Application Priority Data
Dec. 13, 2006 (JP) 2006-336223

(51) Int. Cl. B23Q 1/44; B23Q 16/10

(52) U.S. Cl. 269/57; 269/61; 269/63

(57) ABSTRACT

A turntable includes a driving source, a workpiece holder holding a workpiece to be processed by a tool, a motive power transmission mechanism that can transmit the motive power from said driving source to said workpiece holder, and a load mechanism that can activate said motive power transmission mechanism under a load-applied state, and applying a predetermined load to said motive power transmission mechanism during processing of said workpiece.

### TECHNICAL FIELD

The present invention relates to a turntable supporting a workpiece, and a working machine including this turntable.

### BACKGROUND ART

As disclosed in Japanese Patent Laying-Open Nos. 10-220425 and 2001-277074, improvement in the positioning accuracy of a workpiece at a turntable, ensuring the rigidity of the device against the load applied to the workpiece during processing, and the like are conventionally noted as critical issues. Turntables subjected to various improvements have been proposed.

Such turntables include a motive power source, a motive power transmission mechanism such as a worm/worm wheel mechanism, a table supporting a workpiece, a brake for securing the position of the table, and the like. In order to reduce the driving load in the rotary operation of the table, the table is rotated without activating the brake, and the brake is activated only after the table has been positioned at the indexed position. Thus, the position of the turntable is fixed.

Patent Document 1: Japanese Patent Laying-Open No. 10-220425

Patent Document 2: Japanese Patent Laying-Open No. 2001-277074

### DISCLOSURE OF THE INVENTION

### Problem to be Solved by the Invention

At the conventional turntable set forth above, the brake is OFF when the table is to be rotated. Subsequently, when a workpiece is to be processed, the drive of the motive power source is ceased and the brake is turned ON after the turntable has been positioned.

In the case where the turntable is to be rotated after a processing step, the driving source must be activated and also the brake must be turned OFF. Thus, the series of operations to position a workpiece and apply processing on the workpiece is rather time-consuming due to the operation of turning ON/OFF the brake.

In view of the foregoing, an object of the present invention is to provide a turntable and working machine directed to reducing the time required for the operations of positioning a workpiece, applying processing, and positioning again the workpiece.

### Means for Solving the Problems

A turntable according to the present invention includes a driving source, a workpiece holder supporting a workpiece that is to be processed by a tool, a motive power transmission mechanism capable of transmitting motive power from the driving source to the workpiece holder, and a load mechanism that can activate the motive power transmission mechanism in a load-applied state, and that can apply a predetermined load to the motive power transmission mechanism during processing of the workpiece. Preferably, the motive power transmission mechanism includes an input shaft to which the motive power from a motive power source is transmitted, and a torque amplify mechanism amplifying torque from the input shaft for transmission to the workpiece holder. A load mechanism is provided at the input shaft. Preferably, the torque amplify mechanism employs a roller gear mechanism. Preferably, the torque amplify mechanism employs a ball gear mechanism. Preferably, the load mechanism includes a plate member provided at the input shaft, a contact member in contact with the plate member, and an urging member pressing the plate member towards the contact member. Preferably, the turntable further includes a brake mechanism, different from the load mechanism. A working machine of the present invention includes the turntable set forth above.

### Advantage of the Invention

According to the turntable of the present invention, the motive power transmission mechanism is driven to set the workpiece at a predetermined position in a state where the load mechanism applies a load to the motive power transmission mechanism. Since a load is applied to the motive power transmission mechanism by the load mechanism when the workpiece is positioned, displacement of the workpiece holder is suppressed even if cutting force or the like is applied to the workpiece. The time for switching between the ON and OFF operations of the brake mechanism, required conventionally, is eliminated, so that the time required for the operation of positioning a workpiece up to processing can be reduced.

### BRIEF DESCRIPTION OF THE DRAWINGS

FIG. 1 is a sectional view of a turntable device according to an embodiment.

FIG. 2 is sectional view taken along line II-II of FIG. 1.

FIG. 3 is a front view of a plate 17.

FIG. 4 is a sectional view representing a first modification of the turntable of the present embodiment.

FIG. 5 is a side sectional view representing a second modification of the turntable of the present embodiment.

FIG. 6 is a sectional view representing the neighborhood of the ball in detail.

FIG. 7 is a sectional view representing a third modification of the turntable of the present embodiment.

### DESCRIPTION OF THE REFERENCE SIGNS

1 turntable device; 2 motor; 3 motive power transmission mechanism; 4 table; 10A bevel gear; 10 rotational shaft; 11 input shaft; 12 output shaft; 13 cam follower; 14 cam groove; 16 disk spring; 17 plate; 18 contact plate; 22 roller cam mechanism; 23 gear mechanism; 30 load mechanism; R1, R2 rotational direction; W workpiece.

### BEST MODES FOR CARRYING OUT THE INVENTION

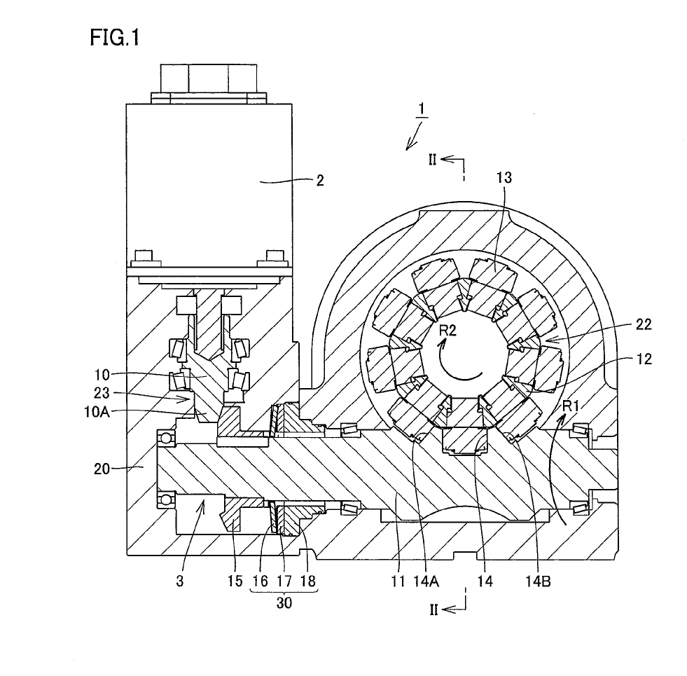

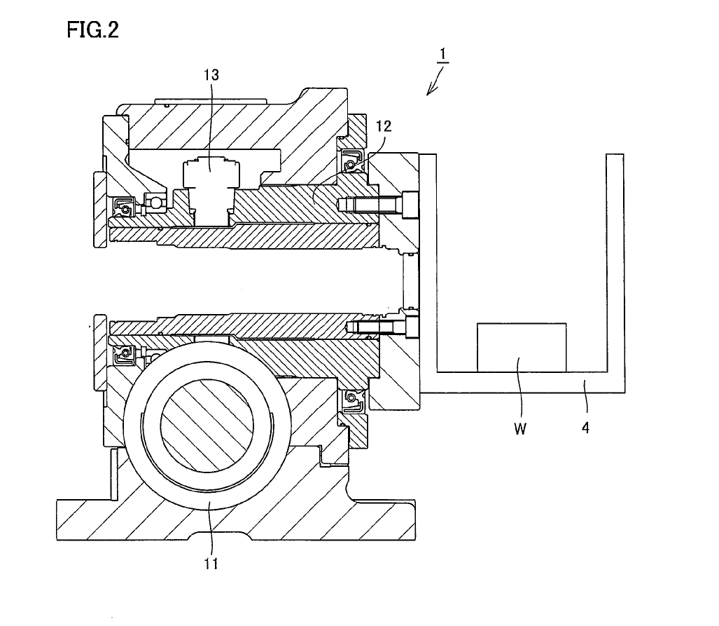

A turntable device (turntable) 1 according to an embodiment will be described hereinafter with reference to FIGS. 1 and 2. FIG. 1 is a sectional view of a turntable device according to the present embodiment, and FIG. 2 is a sectional view taken along line II-II of FIG. 1.

As shown in FIGS. 1 and 2, turntable device 1 includes a motor (driving source) 2, a table (workpiece holder) 4 for holding a workpiece W that is to be processed by a tool not shown, a motive power transmission mechanism 3 transmitting the motive power from motor 2 to table 4, and a load mechanism 30 that can activate motive power transmission mechanism 3 in a load-applied state, and that can apply a predetermined load to motive power transmission mechanism 3 during processing of workpiece W.

By driving motor 2, the motive power from motor 2 is transmitted to table 4 shown in FIG. 2 by motive power transmission mechanism 3 to cause rotation of table 4. Then, the drive of motor 2 is ceased, and table 4 stops such that workpiece W is located at a predetermined position.

Load mechanism 30 continues to apply a load to motive power transmission mechanism 3 regardless of whether motive power transmission mechanism 3 is operated or not. Accordingly, a load is applied to motive power transmission mechanism 3 even when the rotation of table 4 is ceased. Therefore, rotation of table 4 can be suppressed even if an external force such as a cutting force is applied to table 4. Table 4 can be maintained at a predetermined position.

Since table 4 is retained during processing by virtue of load mechanism 30 that constantly applies a load to motive power transmission mechanism 3, the operation of turning ON or OFF the brake mechanism and the like, conventionally required at a turntable, is dispensable. The time required for activating the brake mechanism can be eliminated. Similarly, the operation of turning ON and OFF the brake mechanism is not required in the case where table 4 is to be rotated again to carry out processing on another region subsequent to processing on one region of the workpiece. Table 4 can be rotated immediately at the end of the processing step.

Motive power transmission mechanism 3 is housed in a casing 20. Motive power transmission mechanism 3 includes a gear mechanism (first torque amplify mechanism) 23 transmitting the motive power from motor 2 to input shaft 11, and a roller cam mechanism (second torque amplify mechanism) 22 transmitting the motive power from input shaft 11 to output shaft 12 having the table provided.

Gear mechanism 23 includes a bevel gear 10A provided at rotational shaft 10 of motor 2, and an input shaft 11 including a gear unit 15 corresponding to bevel gear 10A.

The reduction ratio of gear mechanism 23 (revolution speed of rotational shaft 10: revolution speed of input shaft 11) is set to 10:1, for example. The torque of rotational shaft 10 is amplified and transmitted to input shaft 11.

Roller cam mechanism 22 includes output shaft 12 formed in a cylindrical configuration, a plurality of cam followers 13 provided on the outer circumferential face of output shaft 12 in a rotatable manner, and a plurality of cam grooves 14 formed at the outer surface of input shaft 11.

A plurality of cam grooves 14 are arranged in the axial direction of input shaft 11, extending in a spiral manner on the outer circumferential face of input shaft 11. For example, when input shaft 11 rotates in a rotational direction R1, as shown in FIG. 1, output shaft 12 rotates in a rotational direction R2.

At this stage, the inner side face of cam groove 14A located foremost in rotational direction R2 of output shaft 12 pushes cam follower 13 in rotational direction R2. With regards to cam groove 14B located hindmost in rotational direction R2 of output shaft 12, cam follower 13 abuts against the inner side face of cam groove 14B in rotational direction R2. Namely, cam groove 14 is sandwiched between two cam followers 13, such that the backlash between input shaft 11 and output shaft 12 is reduced.

It is particularly preferable to establish a pressurized state by preliminarily bringing cam follower 13 into contact with input shaft 11. Cam follower 13 provided in a rotatable manner transmits the motive power from input shaft 11 to output shaft 12 while rotating, such that the friction between cam groove 14 and cam follower 13 is reduced.

Thus, roller cam mechanism 22 can transmit the motive power from input shaft 11 to output shaft 12 in high accuracy, allowing proper positioning of table 4 shown in FIG. 2. Particularly when table 4 stops and workpiece W is to be subjected to processing, displacement of table 4 corresponding to the backlash between cam follower 13 and cam groove 14 can be suppressed. Thus, shifting of positioned table 4 can be suppressed.

The reduction ratio of roller cam mechanism 22 (revolution speed of input shaft 11: revolution speed of output shaft 12) is set to 9:1, for example. The torque from input shaft 11 is amplified and transmitted to output shaft 12.

Load mechanism 30 is provided at input shaft 11. The load transmitted to output shaft 12 is amplified by roller cam mechanism 22 to become larger than the load applied to input shaft 11 by load mechanism 30. Therefore, the cutting force applied to workpiece W during processing of workpiece W shown in FIG. 2 can be accepted. Displacement of positioned table 4 by the cutting force can be suppressed.

During the processing step on workpiece W while table 4 is being rotated, load mechanism 30 can apply torque to input shaft 11, larger in level than the torque caused by the cutting force applied to workpiece W. Therefore, displacement of table 4 by the cutting force can be suppressed. Processing at high accuracy is allowed even in the case where continuously-rotating cutting or the like is carried out.

By providing roller cam mechanism 22 suppressed in backlash in the motive power transmission path at a downstream side than load mechanism 30, motive power transmission mechanism 3 can suppress the inconvenience of table shifting caused by backlash in the motive power transmission path at a downstream side than load mechanism 30 when the rotation of input shaft 11 is stopped by load mechanism 30. Moreover, the provision of roller cam mechanism 22 in the motive power transmission path at a downstream side than load mechanism 30 allows the load from load mechanism 30 to be amplified. Therefore, position shifting of the table can be suppressed even during the processing step on the workpiece. Thus, processing is allowed at high accuracy.

Gear mechanism 23 with backlash greater than that of roller cam mechanism 22 is provided in the motive power transmission direction at the upstream side than load mechanism 30. Therefore, the movement of elements in motive power transmission mechanism 3 located at a downstream side than gear mechanism 23 can be arrested by load mechanism 30 during processing of workpiece W. Thus, the effect of the backlash of gear mechanism 23 on the position of table 4 is suppressed.

By amplifying the load of load mechanism 30 through roller cam mechanism 22, load mechanism 30 can be formed more compact than the case where load mechanism 30 is provided at output shaft 12.

The pressing force applied by load mechanism 30 to input shaft 11 is smaller than the motive power transmitted to input shaft 11 by gear mechanism 23, and larger than the cutting force transmitted via roller cam mechanism 22 during the processing stage.

In the case where the output of motor 2 is set to 4 N•m and the reduction ratio of gear mechanism 23 is set to 10:1, for example, input shaft 11 can output 40 N•m. Therefore, an output of 28 to 32 N•m is allowed when load mechanism 30 applies the load of 8 to 12 N•m. Moreover, by virtue of load mechanism 30 applying a load of 8 to 12 N•m when the reduction ratio of roller cam mechanism 22 is set to 9:1, a load up to 72 N·m to 108 N·m can be borne.

Load mechanism 30 includes a disk plate (plate member) 17 affixed to the outer circumferential face of input shaft 11, a contact plate (contact member) 18 provided in casing 20 and in contact with plate 17, and a disk spring (urging member) 16 pressing plate 17 towards contact plate 18.

Disk spring 16 is brought into contact with a region of plate 17 located at the outer perimeter side of the side face of plate 17. Therefore, the friction caused between the side face of plate 17 and contact plate 18 becomes larger as a function of approaching the outer perimeter of plate 17. A friction force, as small as it may be, can increase the load torque applied to plate 17. Accordingly, a small compact disk spring 16 can be employed, allowing the device to be reduced in size.

A bearing such as a ball bearing that supports output shaft 12 in a rotatable manner is provided in plurality at output shaft 12. Lubrication oil is fed to the bearing in order to reduce the resistance at the bearing.

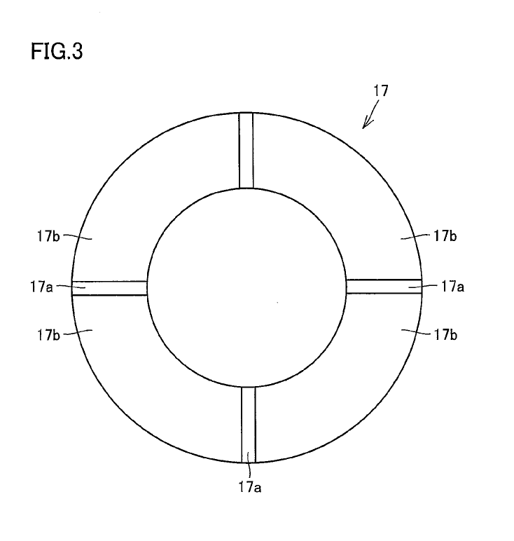

FIG. 3 is a front view of plate 17. As shown in FIG. 3, the surface of plate 17 at the side that faces contact plate 18 shown in FIG. 1 has a radially-extending groove (concave) 17a formed. A contacting face (convex) 17b formed in contact with contact plate 18 is located at the region adjacent to groove 17a.

The lubrication oil introduced between contacting face 17b and contact plate 18 is discharged outside through groove 17a. Accordingly, formation of an oil film between contacting face 17b and contact plate 18 can be suppressed, so that friction between contacting face 17b and contact plate 18 can be ensured. It is to be noted that the configuration of groove 17a is not limited to the example shown in FIG. 3.

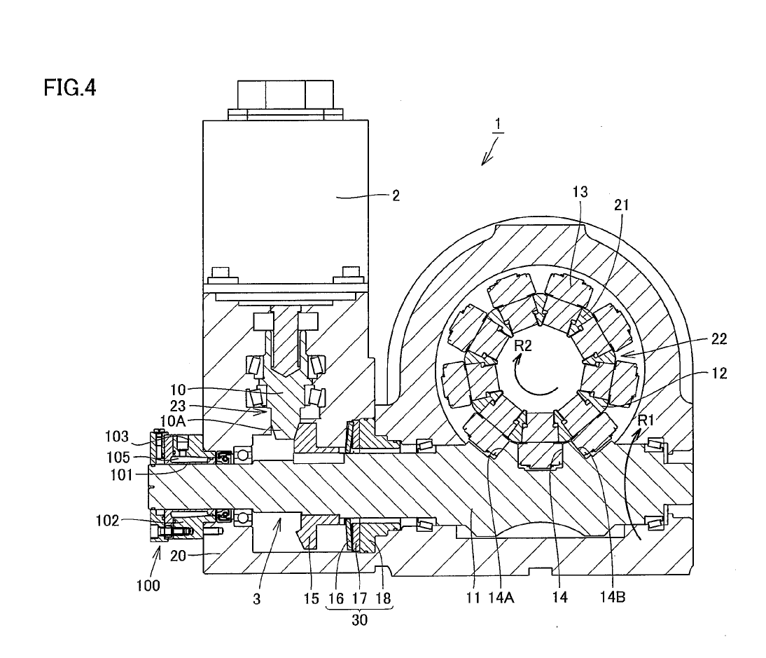

FIG. 4 is a sectional view representing a first modification of the turntable according to the present embodiment. As shown in FIG. 4, turntable device 1 includes an input shaft 11 protruding out of casing 20, and a brake mechanism 100 provided outside casing 20, and capable of suppressing rotation of input shaft 11.

When a cutting force of a level that cannot stop the rotation of input shaft 11 with the load of load mechanism 30 is applied to table 4, brake mechanism 100 can apply additional load to input shaft 11 to suppress displacement of input shaft 11. Brake mechanism 100 includes a cylindrical brake member 101 located outside casing 20, pressing against the outer surface of input shaft 11, and a case 102 disposed along the outer circumference of brake member 101.

An oil chamber 105 is formed between brake member 101 and case 102. An oil pipe 103 is connected to oil chamber 105.

By selectively feeding oil into oil chamber 105, brake mechanism 100 can be driven to retain input shaft 11 when the load applied to the workpiece during processing cannot be supported just by load mechanism 30.

By driving brake mechanism 100 only when processing involved with a large load is to be applied to the workpiece and effecting support by load mechanism 30 alone when general processing is to be applied, the operation time required in a general processing mode can be reduced.

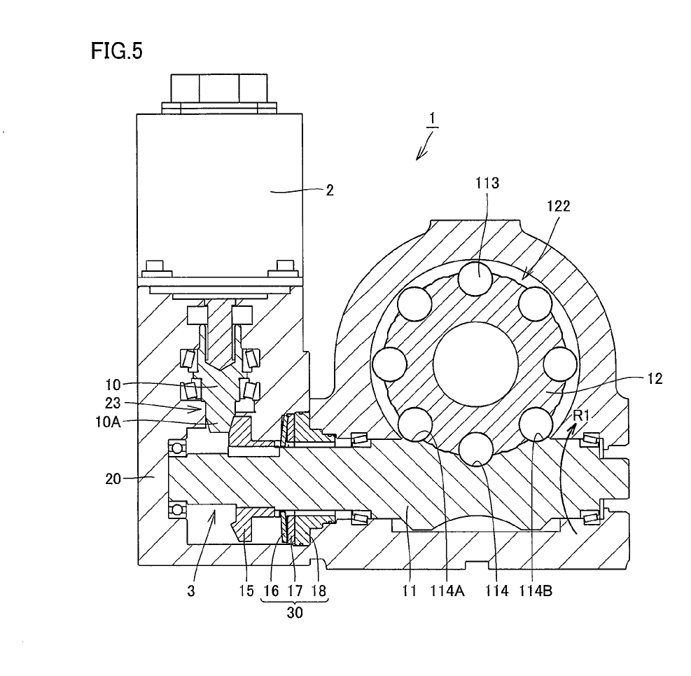

FIG. 5 is a side sectional view representing a second modification of a turntable of the present embodiment. In the modification shown in FIG. 5, motive power transmission mechanism 3 includes a gear mechanism (first torque amplify mechanism) 23 transmitting the motive power from motor 2 to input shaft 11, and a ball gear mechanism (third torque amplify mechanism) 122 transmitting the motive power from input shaft 11 to the output shaft where the table is provided.

Ball gear mechanism 122 includes output shaft 12 formed in a cylindrical configuration, a ball (sphere member) 113 provided in a rotatable manner to output shaft 12, and a cam groove 114 formed at the outer surface of input shaft 11.

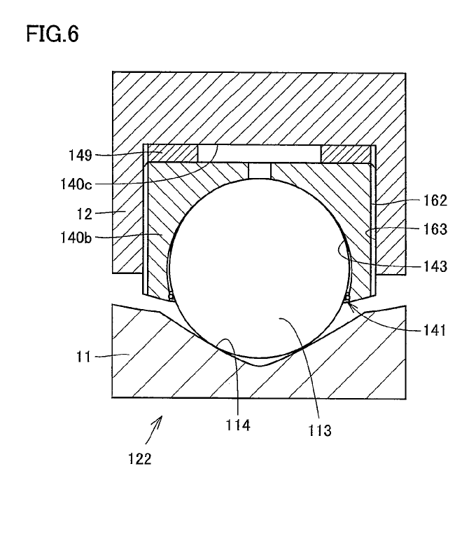

FIG. 6 is a sectional view representing the neighborhood of ball 113 in detail. In the modification shown in FIG. 6, ball gear mechanism 122 includes an adjustment member 140b provided in a concave 140c formed at output shaft 12, a ball 113 provided in a dent 143 formed at adjustment member 140b, an adjustment member 140b, and a sheet member 149 such as a shim.

A thread portion 162 is formed at the perimeter face of adjustment member 140b. A thread portion 163 to be screwed with thread portion 162 is formed at the inner circumferential face of concave 140c.

Accordingly, adjustment member 140b allows position adjustment of output shaft 12 in the radial direction. By adjusting the position of adjustment member 140b, ball 113 can be pushed into cam groove 114.

Thus, the backlash between input shaft 11 and output shaft 12 shown in FIG. 5 can be suppressed. Any slight rotation of output shaft 12, which may occur when input shaft 11 stops, can be suppressed.

Dent 143 of adjustment member 140b is formed at the end face of adjustment member 140b located at the outer side of output shaft 12 in the radial direction. Ball 113 is set in a rotatable manner in dent 143, and is retained in dent 143 by an anti-fallout portion 141 provided at the edge of the opening of dent 143.

Thus, ball 113 rotating in dent 143 can reduce the friction against cam groove 114, such that the motive power from input shaft 11 can be transmitted to output shaft 12 without loss.

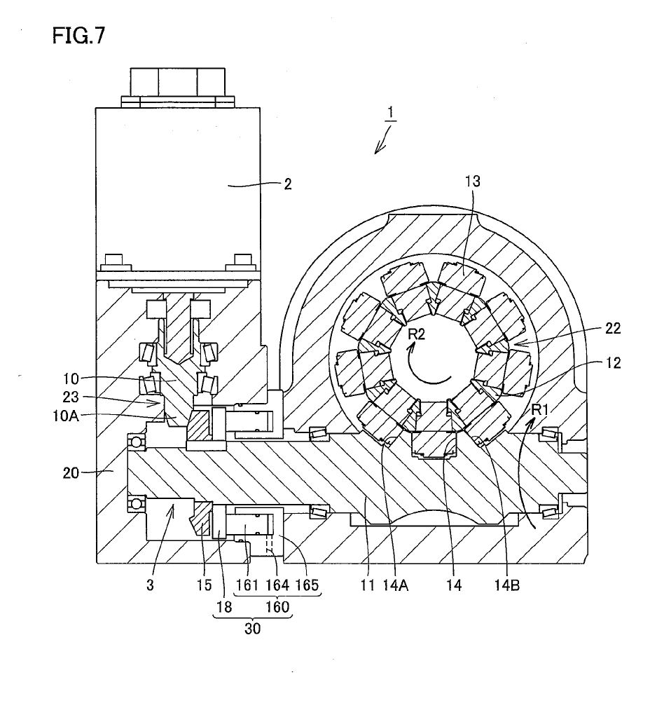

FIG. 7 is a sectional view representing a third modification of a turntable according to the present embodiment. In the modification shown in FIG. 7, load mechanism 30 includes an annular contact plate 18 affixed at the outer circumferential face of input shaft 11, and a hydraulic cylinder 160 provided at casing 20.

This hydraulic cylinder 160 includes a rod 161 provided to move back and forth with respect to contact plate 18, a cylinder portion 165 moving rod 161 back and forth by the oil pressure of the oil (medium) supplied therein, and an oil pipe (oil-feed mechanism) 164 that can supply oil into cylinder portion 165.

By selectively withdrawing the tip of rod 161 from the surface of contact plate 18, the load applied to input shaft 11 can be eliminated selectively. Accordingly, by detaching rod 161 from contact plate 18 and reducing the rotational resistance of input shaft 11, table 4 can be rotated selectively at high speed, allowing the processing time to be reduced.

Moreover, by increasing the load applied to input shaft 11 when table 4 is positioned at the set position, table 4 can be arrested at the set position.

By adjusting the oil pressure in cylinder portion 165, the frictional force between rod 161 and contact plate 18 can be adjusted, allowing adjustment of the load applied to input shaft 11. Therefore, likewise with the example shown in FIG. 1 set forth above, by processing workpiece W while applying a load of a level that allows rotation by the motive power from motor 2, and then increasing the load applied to input shaft 11 when table 4 is located at a predetermined position, the position of table 4 can be immobilized to suppress position shifting of workpiece W.

Although the embodiments of the present invention have been described as set forth above, it is clearly understood that the same is by way of illustration and example only and is not to be taken by way of limitation. The scope of the present invention is defined by the terms of the claims, and is intended to include any modification within the scope and meaning equivalent to the terms of the claims. Moreover, the numeric values set forth above are cited by way of example, and the numeric value as well as the range set forth above are not limited thereto.

### INDUSTRIAL APPLICABILITY

The present invention is suitable for a turntable and a working machine including this turntable.

1. A turntable comprising:
a driving source,
a workpiece holder for holding a workpiece to be processed by a tool,
a motive power transmission mechanism that can transmit a motive power from said driving source to said workpiece holder, and
a load mechanism that can activate said motive power transmission mechanism in a load-applied state, and that applies a predetermined load to said motive power transmission mechanism during processing of said workpiece.

2. The turntable according to claim 1, wherein said motive power transmission mechanism includes
an input shaft to which the motive power from said driving source is transmitted, and
a torque amplify mechanism amplifying torque from said input shaft for transmission to said workpiece holder,
said load mechanism being provided at said input shaft.

3. The turntable according to claim 2, wherein said torque amplify mechanism employs a roller gear mechanism.

4. The turntable according to claim 2, wherein said torque amplify mechanism employs a ball gear mechanism.

5. The turntable according to claim 1, wherein said load mechanism includes
a plate member provided at said input shaft,
a contact member in contact with said plate member, and
an urging member pressing said plate member towards said contact member.

6. The turntable according to claim 5, further comprising a concave and convex region formed at a surface of said plate member, at a region in contact with said contact member.

7. The turntable according to claim 1, further comprising a brake mechanism, different from said load mechanism.

8. A working machine comprising the turntable defined in claim 1.
